(19) United States
(12) Patent Application Publication
(10) Pub. No.: US 2004/0199673 A1
(43) Pub. Date: Oct. 7, 2004

(54) Electronic peripheral device and network card

(75) Inventors: Sea-Weng Young, Pingtung (TW); Shao-Yu Wang, Taoyuan City (TW); Ke-Chi Tu, Chiayi City (TW)

Correspondence Address: LADAS & PARRY, 5670 WILSHIRE BOULEVARD, SUITE 2100, LOS ANGELES, CA, 90036-5679, US

(73) Assignee: BENQ Corporation

(21) Appl. No.: 10/759,696

(22) Filed: Jan. 16, 2004

(30) Foreign Application Priority Data
Feb. 27, 2003 (TW) 92104183

(51) Int. Cl. G06F 3/00

(52) U.S. Cl. 710/1

(57) ABSTRACT

A electronic peripheral device. The electronic peripheral device is coupled to an electronic system and selectively coupled to either of a first wireless network or a second wireless network. The electronic peripheral device comprises a first module for accessing the first wireless network, a second module for accessing the second wireless network, and a processor. When the electronic system is coupled to the first wireless network, signals from the first wireless network are received by the first module and transmitted to the electronic system through the second module, and signals from the electronic system transmitted to the first wireless network are controlled by the processor. When the electronic system is coupled to the second wireless network, signals from the second wireless network are received by the second module and transmitted to the electronic system, and signals from the electronic system transmitted to the second wireless network are controlled by the processor.

### BACKGROUND OF THE INVENTION

1. Field of the Invention

The present invention relates to an electronic device and particularly to an electronic peripheral device with an interface. By the electronic peripheral device, an electronic system coupled to the electronic peripheral device can selectively connect to either of two different wireless networks.

2. Description of the Prior Art

A number of wireless network technologies have been proposed during the past few years. New radio access technologies and wireless network standards are also being developed. It is believed that multiple standards will coexist in the same environment for future wireless communication systems. Seamless roaming between different networks is becoming more and more important in multiple standard environments. Different radio access networks have their own properties. High-tier systems such as General Packet Radio Service (GPRS) and Universal Mobile Telecommunication System (UMTS) provide high mobility with lower data transmission bandwidth. On the other hand, low-tier systems such as wireless local area network (Wireless LAN, WLAN) provide high data bandwidth but with less mobility. According to different requirements, electronic systems such as personal computers, notebooks, or PDAs can connect to different wireless networks via different electronic peripheral devices such as a network card. To increase convenience, one electronic peripheral device supporting two or more wireless standards is provided. By the electronic peripheral device, a electronic system can selectively connect to different wireless networks.

FIG. 1 is a diagram illustrating a configuration of a network card supporting the GPRS standard and the WLAN standard. As shown in FIG. 1, through a PCMCIA interface 140, the network card is connected to an electronic system such as a personal computer, a notebook, or a PDA. Via a WLAN module 110, the network card can connect to a WLAN network (not shown in FIG. 1). Via a GPRS module 120, the network card can connect to a GPRS network (not shown in FIG. 1). Via a data bus 160, signals are transmitted between the WLAN module 110 or the GPRS module 120 and the PCMCIA card 140.

PCMICIA bridges 112 and 122 are coupled to a control chip 130, and respectively coupled to the WLAN module 110 and the GPRS module 120. The PCMICIA bridges 112 and 122 respectively transform signals from the WLAN module 110 and GPRS module 120 to PCMCIA signals. For the electronic system to access the WLAN network, the control chip 130 instructs the GPRS module 120 to stop receiving and transmitting signals through the data bus 160. Signals are received and transmitted by the WLAN module 110 through the data bus 160. For the electronic system to access the GPRS network, the control chip 130 instructs the WLAN module 110 to stop receiving and transmitting signals through the data bus 160. The network card with the PCMCIA bridges 112 and 122 and the control chip 130 requires considerable space. Thus, development costs are increased.

Furthermore, for software of the network card and driver of network card, in the PCMCIA interface, a GPRS application program and a WLAN application program, each correspond respectively to the GPRS link layer and the WLAN link layer, are individually required, hence, design time is increased. Because the control chip 130 switches between the GPRS application program and the WLAN application program, to perform parallel operation, extra interrupt procedures for drivers of network card are needed in programs of the electronic systems. Thus, software design is made considerably more complex.

### SUMMARY OF THE INVENTION

The object of the present invention is to provide an electronic peripheral device without a bridge or control chip. By the electronic peripheral device, an electronic system coupled to the electronic peripheral device can selectively connect to either of two different wireless networks. As space of the electronic peripheral device is decreased, development cost is, as well.

An object of the present invention is to provide an electronic peripheral device which integrates different wireless network modules via a USB interface or a Universal Asynchronous Receiver/Transmitter (UART) interface. By the hardware integration, the design cost of software corresponding with the electronic peripheral device is decreased.

The present invention provides an electronic peripheral device coupled to an electronic system. By the electronic peripheral device, the electronic system is selectively coupled to a first wireless network or a second wireless network. The electronic peripheral device comprises a first module and a second module. By the first module, the electronic system can access the first wireless network. By the second module, the electronic system can access the second wireless network. The first module comprises at least a first interface. The second module comprises at least a second interface, a third interface, and a processor. The second interface is coupled to the first interface. Through the second interface, a plurality of signals are transmitted between the first module and the second module. The third interface is coupled to the electronic system. Through the third interface, a plurality of first signals or second signals are transmitted between the electronic system and the second module.

The processor controls the transmission of the first signals and second signals in the third interface. When the electronic system is coupled to the first wireless network, the first module transmits the first signals received from the first wireless network to the electronic system through the first interface, the second interface, and the third interface in order, and transmits the first signals received from the first interface to the first wireless network. When the electronic system is coupled to the second wireless network, the second module transmits the second signals received from the second wireless network to the electronic system through the third interface, and transmits the second signals received from the third interface to the second wireless network.

The first wireless network can be a Global System for Mobile Communications (GSM) network or a General Packet Radio Service (GPRS) network. The second wireless network can be a Wireless Local Area Network (WLAN).

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram illustrating a configuration of a network card supporting the GPRS standard and the WLAN standard in the prior art.

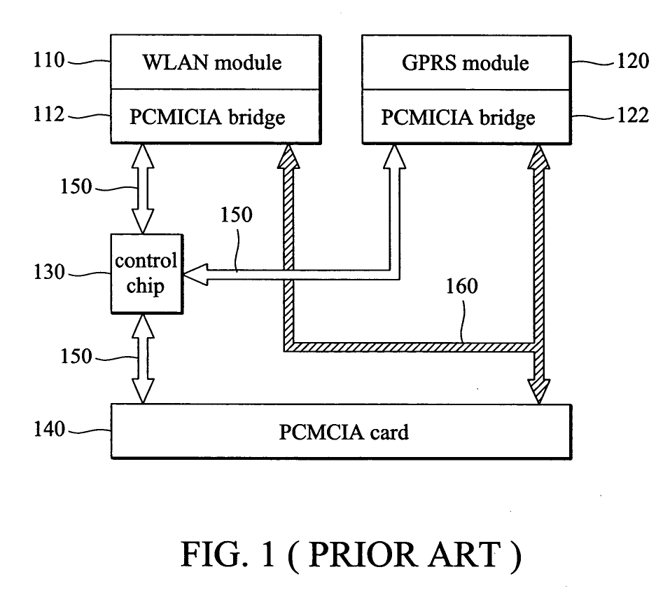

FIG. 2 is a diagram illustrating a configuration of an electronic peripheral device and an electronic system coupled to the electronic peripheral device in the present invention.

FIG. 3 is a diagram illustrating a configuration of an electronic peripheral device and an electronic system coupled to the electronic peripheral device according to the first embodiment of the present invention.

FIG. 4 is a diagram illustrating a configuration of a network card and an electronic system coupled to the electronic peripheral device according to the second embodiment of the present invention.

### DETAILED DESCRIPTION OF THE INVENTION

The invention provides an electronic peripheral device without bridges. By the electronic peripheral device, an electronic system coupled to the electronic peripheral device can selectively connect to either of two different wireless networks.

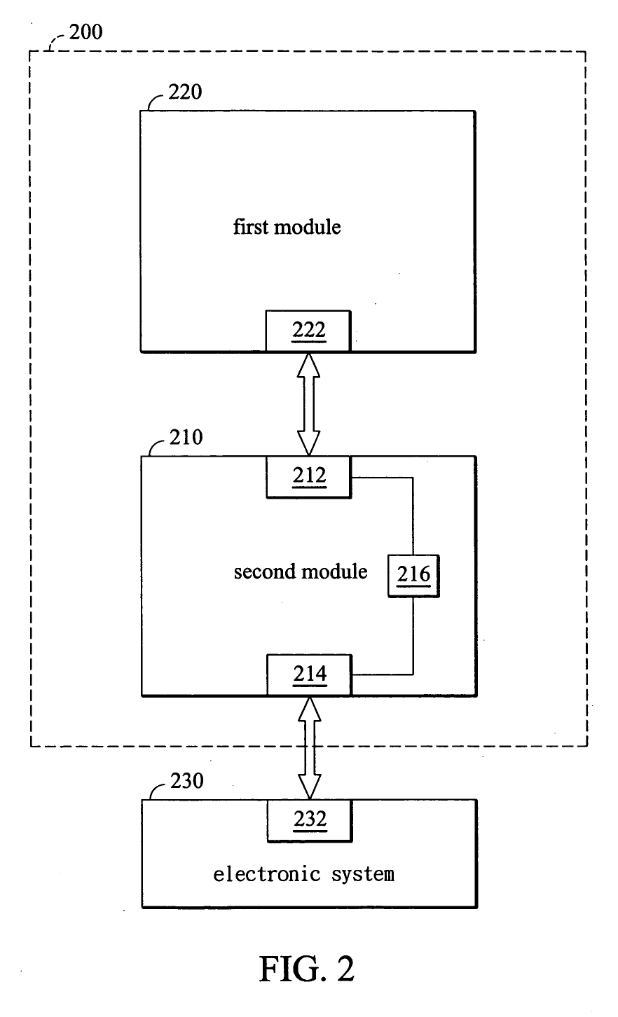

FIG. 2 is a diagram illustrating a configuration of an electronic peripheral device and an electronic system coupled to the electronic peripheral device in the present invention. As shown in FIG. 2, the electronic peripheral device 200 is coupled to an electronic system 230. By the electronic peripheral device 200, the electronic system 230 is selectively coupled to a first wireless network (not shown in FIG. 2) or a second wireless network (not shown in FIG. 2). The electronic peripheral device 200 comprises a first module 220 and a second module 210. By the first module 220, the electronic system 230 can access the first wireless network. By the second module 210, the electronic system 230 can access the second wireless network. The first module 220 comprises at least one first interface 222. The second module 210 comprises at least one second interface 212, a third interface 214 and a processor 216. The second interface 212 is coupled to the first interface 222. Through the second interface 212, a plurality of signals are transmitted between the first module 220 and the second module 210. The third interface 214 is coupled to the electronic system 230. Through the third interface 214, first wireless network signals and second wireless network signals are transmitted between the electronic system 230 and the second module 210. The processor 216 controls the transmission of the first wireless network signals and the second wireless network signals in the third interface 214.

An electronic peripheral device coupled to the GPRS network and the WLAN network is used as an example to illustrate an embodiment of the present invention.

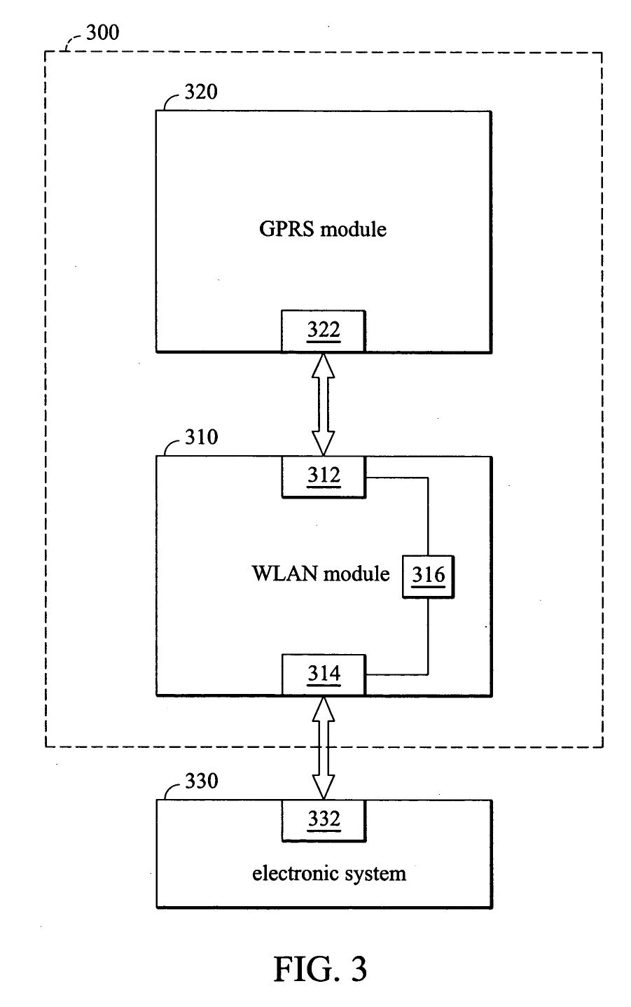

FIG. 3 is a diagram illustrating a configuration of an electronic peripheral device and an electronic system coupled to the electronic peripheral device according to the first embodiment of the present invention. As shown in FIG. 3, the electronic peripheral device 300 comprises a WLAN module 310 and a GPRS module 320. The electronic peripheral device 300 is connected to an electronic system 330 such as a personal computer, a notebook or a PDA. By the electronic peripheral device 300, the electronic system 330 is selectively coupled to the WLAN network (not shown in FIG. 3) or the GPRS network (not shown in FIG. 3).

By the GPRS module 320, the electronic system 330 can access the GPRS network. The GPRS module 320 comprises at least one interface 322. The interface 322 may be a USB interface or a UART interface.

By the WLAN module 310, the electronic system 330 can access the WLAN network. The WLAN module 310 comprises at least one interface 312, an interface 314, and a processor 316. The interface 312 coupled to the interface 322 may be a USB interface or a UART interface. The standard of the interface 312 is the same as that of the interface 322. Through the second interface 312, signals are transmitted between the WLAN module 310 and the GPRS module 320.

The interface 314 coupled to the electronic system 330 may be a PCMCIA interface, a PCI interface, a CardBus interface, or a USB interface. The standard of the interface 314 is the same as that of an interface 332 in the electronic system 330. Through the interface 314, GPRS signals and WLAN signals are transmitted between the electronic system 330 and the WLAN module 310.

The processor 316 controls the transmission of the GPRS signals and the WLAN signals in the interface 314. When the electronic system 330 is coupled to the GPRS network, the GPRS module 320 receives GPRS signals from the GPRS network. Then, the GPRS signals are transmitted to the electronic system 330 through the interface 322, the interface 312, and the interface 314 in order. In addition, the interface 322 receives the GPRS signals transmitted from the electronic system 330 through the interface 314 and the interface 312 in order. Then, the GPRS signals are transmitted to the GPRS network through the GPRS module 320. When the electronic system 330 is coupled to the WLAN network, the WLAN module 310 receives WLAN signals from the WLAN network. Then, the WLAN signals are transmitted to the electronic system 330 through the interface 314. In addition, the WLAN signals from the electronic system 330 are transmitted to the WLAN network through the WLAN module 310. Based on the above structure of the electronic peripheral device, all data coming from the electronic system 330 passes through the interface 314, the WLAN interface. The driver of the electronic peripheral device can be designed as WLAN driver with less interrupt procedures.

The electronic peripheral device of the present invention may connect networks, such as a network card. A network card coupled to the GPRS network and the WLAN network is used as an example to illustrate another embodiment of the present invention.

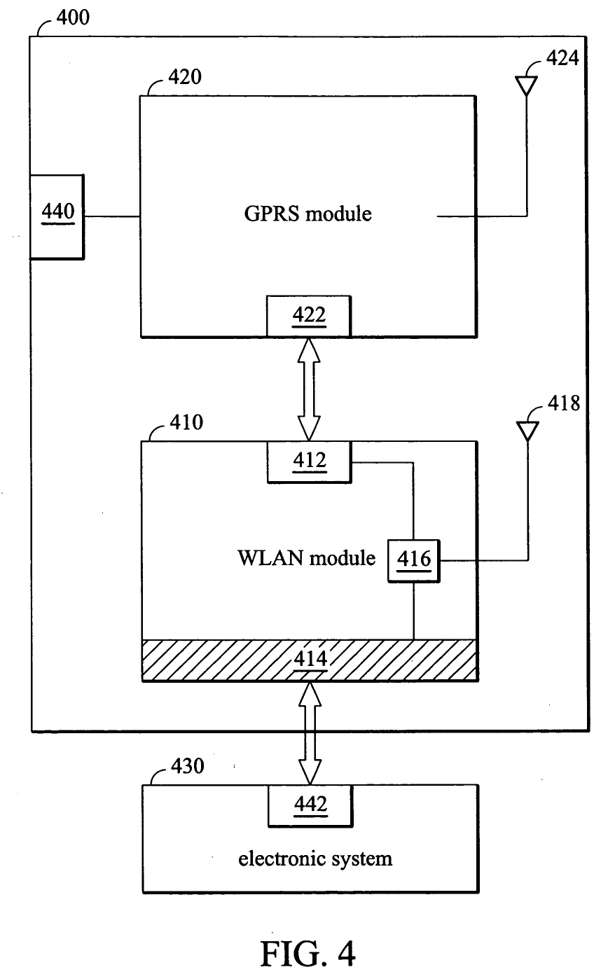

FIG. 4 is a diagram illustrating a configuration of a network card coupled an electronic system according to the second embodiment of the present invention. As shown in FIG. 4, the network card 400 comprises a WLAN module 410, a GPRS module 420, a GPRS antenna 424, a WLAN antenna 418 and an audio output port 440. The network card 400 is connected to an electronic system 430 such as a personal computer, a notebook or a PDA. The electronic system 430 is selectively coupled to the WLAN network (not shown in FIG. 3) by the WLAN antenna 418 or the GPRS network (not shown in FIG. 3) by the GPRS antenna 424.

By the GPRS module 420, the electronic system 430 can access the GPRS network. The GPRS module 420 comprises at least one interface 422. The interface 422 may be a USB interface or a UART interface.

By the WLAN module 410, the electronic system 430 can access the WLAN network. The WLAN module 410 comprises at least one interface 412, an interface 414 and a processor 416. The interface 412 coupled to the interface 422 may be a USB interface or a UART interface. The standard of the interface 412 is the same as that of the interface 422. Through the second interface 412, signals are transmitted between the WLAN module 410 and the GPRS module 420.

The interface 414 coupled to the electronic system 430 may be a PCMCIA interface, a PCI interface, a Card Bus interface, or a USB interface. The standard of the interface 414 is the same as that of an interface 432 in the electronic system 430. Through the interface 414, GPRS signals and WLAN signals are transmitted between the electronic system 430 and the WLAN module 410.

The processor 416 controls the transmission of the GPRS signals and the WLAN signals in the interface 414. When the electronic system 430 is coupled to the GPRS network, the GPRS module 420 receives GPRS signals from the GPRS network. Then, the GPRS signals are transmitted to the interface 432 of the electronic system 430 through the interface 422, the interface 412, and the interface 414 in order. In addition, the interface 422 receives the GPRS signals transmitted from the interface 432 of the electronic system 430 through the interface 414 and the interface 412 in order. Then, the GPRS signals are transmitted to the GPRS network through the GPRS module 420. When the electronic system 430 is coupled to the WLAN network, the WLAN module 410 receives WLAN signals from the WLAN network. Then, the WLAN signals are transmitted to the interface 432 of the electronic system 430 through the interface 414. In addition, the WLAN signals from the electronic system 430 are transmitted to the WLAN network through the WLAN module 410.

The audio output port 440 is coupled to a an audio output deceive, such as a speaker phone. In the present invention, a processor of the WLAN module 410 (not shown in FIG. 4) can control the GPRS module 420. Thus, when the GPRS module determines to upgrade the firmware, updated information for the firmware may be downloaded by the audio output port 442.

The WLAN module 410 comprises a chip ZD 1201 from ZyDAS. If the WLAN module 410 is the chip, the interface 414 for coupled to the electronic system is a PCMICAI interface.

Furthermore, for software design of the network card, in the PCMIC interface, a GPRS application program and a WLAN application program correspond respectively to the GPRS link layer and the WLAN link layer with no requirement for individually dedicated programs. The processor of the WLAN module 410 can control the GPRS module 420. Thus, adding GPRS function corresponding to the GPRS link layer upon the WLAN application program can decrease the complex of software design.

By the electronic peripheral device provided by the present invention, an electronic system coupled to the electronic peripheral device can selectively connect to either of two different wireless networks. The size of the electronic peripheral device is thus decreased, and development costs are decreased. By the hardware integration, the design cost of software corresponding to the electronic peripheral device is also decreased.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An electronic peripheral device for coupling to an electronic system, the electronic system being selectively coupled to a first wireless network or a second wireless network by the electronic peripheral device, the electronic peripheral device comprising:
a first module with which the electronic system accesses the first wireless network, comprising a first interface; and
a second module with which the electronic system accesses the second wireless network, comprising:
a second interface coupled to the first interface for transmitting a plurality of signals between the first module and the second module;
a third interface coupled to the electronic system for transmitting a plurality of first signals or a plurality of second signals between the electronic system and the second module; and
a processor for controlling the transmission of the first signals and second signals;
wherein when the electronic system is coupled to the first wireless network, the first module transmits the first signals received from the first wireless network to the electronic system through the first interface, the second interface, and the third interface in order, and transmits the first signals received from the first interface to the first wireless network; and when the electronic system is coupled to the second wireless network, the second module transmits the second signals received from the second wireless network to the electronic system through the third interface, and transmits the second signals received from the third interface to the second wireless network.

2. The electronic peripheral device as claimed in claim 1, wherein the first wireless network is a General Packet Radio Service (GPRS) network.

3. The electronic peripheral device as claimed in claim 1, wherein the first wireless network is a Global System for Mobile Communications (GSM) network.

4. The electronic peripheral device as claimed in claim 1., wherein the second wireless network is a Wireless Local Area Network (WLAN).

5. The electronic peripheral device as claimed in claim 1, wherein the first interface and the second interface are Universal Serial Bus (USB) interfaces.

6. The electronic peripheral device as claimed in claim 1, wherein the first interface and the second interface are Universal Asynchronous Receiver/Transmitter (UART) interfaces.

7. The electronic peripheral device as claimed in claim 1, wherein the third interface is a Personal Computer Memory Card International Association (PCMCIA) interface.

8. The electronic peripheral device as claimed in claim 1, wherein the third interface is a Personal Component Interconnect (PCI) interface.

9. The electronic peripheral device as claimed in claim 1, wherein the third interface is a CardBus interface.

10. The electronic peripheral device as claimed in claim 1, wherein the third interface is a USB interface.

11. A network card for coupling to an electronic system, the electronic system being selectively coupled to a first wireless network or a second wireless network, comprising:
a first module for accessing the first wireless network, comprising a first interface; and
a second module for accessing the second wireless network, comprising:
a second interface coupled to the first interface for transmitting a plurality of first signals between the first module and the second module;
a third interface for coupling to the electronic system for transmitting the first signals or a plurality of second signals between the electronic system and the second module; and
a processor for controlling the transmission of the first signals and the second signals;
wherein when the electronic system is coupled to the first wireless network, the first module communicated with the electronic by the first signals; and when the electronic system is coupled to the second wireless network, the second module communicated with the electronic by the second signals.

12. The network card as claimed in claim 11, wherein the first wireless network is a GPRS network.

13. The network card as claimed in claim 11, wherein the first wireless network is a GSM network.

14. The network card as claimed in claim 11, wherein the second wireless network is a WLAN.

15. The network card as claimed in claim 11, wherein the first interface and the second interface are USB interfaces.

16. The network card as claimed in claim 11, wherein the first interface and the second interface are UART interfaces.

17. The network card as claimed in claim 11, wherein the third interface is a PCMCIA interface.

18. The network card as claimed in claim 11, wherein the third interface is a PCI interface.

19. The network card as claimed in claim 11, wherein the third interface is a CardBus interface.

20. A network card for coupling to a first connecting interface of an electronic system, the electronic system is selectively coupled to a first wireless network or a second wireless network by the network card, the network card comprising:
a first wireless module for accessing the first wireless network; and
a second wireless module for accessing the second wireless network and coupling to the first wireless module, the second wireless module comprising:
a second connecting interface coupled to the first connecting interface; and
a processor for controlling the transmission between the electronic system and the first wireless module or the transmission between the electronic system and the second wireless module;
wherein when the electronic system is coupled to the first wireless network, the transmission between the electronic system and the first wireless module passing through the second wireless module; when the electronic system is coupled to the second wireless network, the transmission between the electronic system and the second wireless module transmitting directly.
